(19) United States
(12) Patent Application Publication
(10) Pub. No.: US 2008/0285157 A1
(43) Pub. Date: Nov. 20, 2008

(54) Rearview Mirror for a Motor Vehicle

(75) Inventor: Daniel Goraguer, Rouen (FR)

Correspondence Address: SUGHRUE MION, PLLC, 2100 PENNSYLVANIA AVENUE, N.W., SUITE 800, WASHINGTON, DC, 20037, US

(73) Assignee: HOLOPHANE SA, Les Andelys (FR)

(21) Appl. No.: 12/096,401

(22) PCT Filed: Dec. 8, 2006
(86) PCT No.: PCT/FR2006/051312

§ 371 Date: Jun. 6, 2008

(30) Foreign Application Priority Data
Dec. 9, 2005 (FR) 0553813

(51) Int. Cl. G02B 17/00

(52) U.S. Cl. 359/727

(57) ABSTRACT

A motor vehicle rearview mirror for producing an image of an object situated outside and behind the vehicle, the rearview mirror comprising a lens (1; 1′; 1″; 1″′) and a mirror (2) and being characterized in that the lens is a diverging concave lens having an optical axis (Al) and an optical focus (Fl; Fl′; Fl″), and the mirror is a mirror that is substantially concave, light beams (Fse, Fc, Fsi) passing through the diverging lens towards the mirror that reflects them in converging manner substantially without optical distortion in a direction that corresponds to the viewing axis of the driver looking at the mirror, characterized in that the mirror (2) defines a concave reflective surface (21) that corresponds substantially to a segment of a cylinder.

The present invention relates to a rearview mirror for a motor vehicle for producing an image of that which is situated outside and behind the vehicle. The term “motor vehicle” is used to cover any type of vehicle including its own self-propulsion means, such as private cars, utility vehicles (vans, trucks, tractors, etc.), and motorcycles. Nevertheless, the present invention is not limited purely to vehicles traveling on land, but can also be applied to other vehicles that travel in the air or on the water. The present invention thus applies most particularly to the field of motor vehicle equipment for assisting the driver by facilitating or enlarging the driver's field of view, in particular rearwards.

Nearly all motor vehicles are fitted with one or two lateral rearview mirrors on the outside enabling the driver to have an image or a field of view of zones that are situated laterally beside the vehicle. Similarly, vehicles are also fitted with an inside rearview mirror giving a field of view directly behind the vehicle. The present invention applies most particularly to lateral rearview mirrors on the outside, but without excluding an inside rearview mirror. Such lateral rearview mirrors conventionally comprise a mirror that is plane or slightly convex in order to increase the field of view in the blind spot, i.e. in the zone situated beside the vehicle, and going away therefrom. With conventional rearview mirrors, the blind spot is particularly dangerous while being overtaken by another vehicle. It sometimes happens that the driver does not see a vehicle engaged to one side for the purpose of overtaking. This can lead to accidents that are sometimes severe. In order to reduce the size of the blind spot, conventional rearview mirrors are often given a convex configuration in their outermost portion so as to extend the field of view into the blind spot.

Furthermore, such conventional rearview mirrors present several additional disadvantages as well as not covering the blind spot in satisfactory manner. Firstly, the rearview mirror increases the lateral outside dimensions of the vehicle, and thus not only constitutes a projecting element that can come into collision with another vehicle, a passerby, or any other structure, but also reduces the vehicle's drag coefficient. To mitigate the space occupies when parking, it is already known to fit conventional rearview mirrors with a system enabling the rearview mirror to be folded down along the vehicle. Nevertheless, incorporating folding mechanisms, whether electrical or purely mechanical, leads to an increase in the number of parts for the rearview mirror as a whole. That increase in the number of parts naturally increases the overall cost of the rearview mirror.

Furthermore, rearview mirror systems are already known that make use of lenses in combination with one or more reflecting mirror(s). This applies to U.S. Pat. No. 6,882,146, for example. In that document, the rearview mirror has an objective lens situated outside the vehicle, a reflective plane mirror, and a field lens situated inside the vehicle. The rearview mirror thus makes use of two different lenses and a plane mirror.

An object of the present invention is to improve such a lens-and-mirror rearview mirror so as to make it easier to fabricate and easier to install, while using a small number of parts, and at reduced cost.

To achieve these objects, the present invention provides a motor vehicle rearview mirror for producing an image of an object situated outside and behind the vehicle, the rearview mirror comprising a lens and a mirror and being characterized in that the lens is a diverging concave lens having an optical axis and an optical focus, and the mirror is a mirror that is substantially concave, light beams passing through the diverging lens towards the mirror that reflects them in converging manner substantially without optical distortion in a direction that corresponds to the viewing axis of the driver looking at the mirror, characterized in that the mirror defines a concave reflective surface that corresponds substantially to a segment of a cylinder. Advantageously, the rearview mirror has only one lens and only one mirror.

Thus, the concave side of the mirror defines a geometrical surface that is relatively simple and particularly easy to produce industrially. It is easy and known how to make cylindrical surfaces using plane sheets or plates so that the resulting surface satisfies the definition of a cylinder. By deforming a plane sheet or plate, it is caused to define a curve in one direction and a straight line in a direction perpendicular thereto. This satisfies the definition for a cylinder which is the result of taking a director curve that may present an arbitrary shape and projecting it along a generator line. A circular cylinder is the result of projecting a circle along a generator line passing through the center of the circle and extending advantageously perpendicularly to the plane in which the circle is defined. On the same geometrical principle, it is possible to define cylinders having a wide variety of cross-sections: the cross-section corresponds to the director curve for the cylinder. In practice, cylindrical surfaces are particularly easy to produce, in particular by extrusion. By causing a deformable material to pass through an extrusion die, there is obtained at the outlet of the die a member of section that corresponds exactly to the shape of the hole made through the die. Such an extruded section can be said to be “cylindrical”. Thus, in the present invention, the concave reflective surface presents a configuration that is cylindrical and that can be made using a fraction, a piece, a cutout, or more generally a segment of a cylinder.

In another advantageous aspect of the invention, the cylinder is parabolic and presents a plane of symmetry and a focal line situated in said plane. A parabola is a two-dimensional curve characterized by a directrix, a focus, and an axis of symmetry. When such a curve is projected along a generator line perpendicular both to the directrix and to the axis of symmetry, a cylinder is obtained of section that defines a parabola. In the invention, the concave reflective surface is made from a fraction, a piece, or a segment of such a cylinder of parabolic section. Naturally, when the parabola is projected along the generator line to form the cylinder, the axis of the parabola is projected along the generator line to form a plane of symmetry, and the point focus of the parabola is likewise projected along the generator line to form a rectilinear focal line that is situated in the plane of symmetry of the parabolic cylinder. According to an advantageous characteristic of the invention, the plane of symmetry is substantially parallel to the viewing axis of the driver looking at the mirror. In other words, the parabolic curvature of the concave reflective surface lies in a plane that is substantially horizontal.

According to another aspect of the invention, the reflective surface of the mirror defines a horizontal mid-line and a vertical mid-line that intersect substantially at the center of the mirror, the horizontal line presenting curvature that is substantially parabolic, the vertical line being substantially straight, and all of the vertical lines being likewise straight, and all of the horizontal lines having the same parabolic curvature as the horizontal mid-line. This definition corresponds to a surface made up from a fraction of a cylinder having a parabola as its director curve.

According to another advantageous characteristic of the invention, the optical focus of the lens defines a focal line. Advantageously, the focal line is disposed substantially vertically relative to the mirror. This focal line may be accurately rectilinear, substantially rectilinear, or even curved. The fact that the lens defines a focal line rather than the focal point means that the lens is not a body of revolution, as is for example a spherical or an aspherical lens. With a lens forming a body of revolution, the optical focus of the lens is a point and it lies on the focal axis which is a line. With a linear optical focus having two dimensions, the optical axis is in the form of an optical plane and the focal line is situated in the optical plane.

In another aspect of the invention, the respective focal lines of the cylinder and of the lens are substantially parallel and distinct, i.e. they do not coincide. In another advantageous aspect, the focal line of the cylinder is situated close to the optical axis of the lens. In this aspect, the optical axis of the lens is an optical plane.

In another aspect of the invention that is particularly advantageous, the lens has a concave front face and a rear face that is substantially plane and facing towards the mirror, the front face defining an optical surface having a configuration that is substantially cylindrical. Thus, both the mirror and the lens present a configuration that is substantially cylindrical. The generator lines of the two cylinders are advantageously parallel and disposed vertically. In an advantageous first embodiment, the optical surface defines a horizontal mid-line and a vertical mid-line that intersect substantially in the center of the optical surface, the horizontal mid-line presenting curvature in a plane that is perpendicular to the vertical mid-line, all of the horizontal lines having substantially the same curvature as the horizontal mid-line in respective planes perpendicular to the vertical mid-line. Advantageously, the curvature of the horizontal lines is circular so as to define a circular arc of determined radius.

In a simple embodiment, the vertical mid-line is straight, as are all of the other vertical lines. The optical surface of the lens then complies exactly or substantially with the definition of a cylinder having its director curve that is advantageously circular. Such a cylindrical lens is particularly easy to make, given that it can be made by extrusion since its cross-section is constant.

In a more elaborate practical embodiment, the vertical mid-line is curved so that the optical surface presents an overall configuration that is toroidal. The vertical curvature may advantageously be circular so as to correspond to a circular arc of determined radius. Nevertheless, the curvature may present any other arbitrary trajectory. The vertical curvature further increases the concave nature of the optical surface. This vertical concave nature has the optical effect of moving vertical field lines towards one another so that subjects visible in the mirror present a more “normal” appearance concerning horizontal and vertical proportions. The horizontal curvature of the lens has the effect of compressing the mirror image so that subjects visible in the mirror are made particularly thin, while retaining a normal height. By also curving the optical surface in the vertical direction, this proportion error of subjects seen in the mirror can be corrected. The optical surface then presents a configuration that corresponds to a segment of a curved tube, that can be said to be generally toroidal. This geometrical configuration is characterized by the fact that the transverse or horizontal curvature in a plane perpendicular to the vertical and longitudinal curvature is constant, e.g. circular.

In another advantageous aspect of the invention, the vertical mid-line presents a bottom zone in which it presents greater curvature. The curvature of the horizontal lines (that do not necessarily lie in horizontal planes) can be kept constant if consideration is given to lines of curvature in planes that are always perpendicular to the curvature of the vertical line. The increase in the curvature in the bottom zone of the optical surface serves to deflect beams strongly downwards, i.e. towards the road surface or the sidewalk, thus enabling the driver to see the zone situated in the vicinity of the sidewalk, even if deformed. This field of view including the sidewalk serves in particular to make it easier to park a motor vehicle well as close as possible to the sidewalk, or at least parallel to the sidewalk. The vertical mid-line can thus present curvature that is substantially constant over the major fraction of its height with greatly increased curvature in its bottom zone.

According to another advantageous aspect of the invention, the lens presents a configuration that is prismatic and suitable for deflecting light beams towards the inside of the car. This prismatic configuration of the lens corresponds to combining or associating a lens with a prism and serves to deflect light beams towards the inside of the vehicle so that the mirror can be installed further inside the vehicle than is possible if this prismatic configuration does not exist. Consequently, the prism incorporated in the lens makes it possible to shift the mirror towards the inside of the vehicle, thereby further reducing the extent to which the rearview mirror projects outside the vehicle.

In another aspect, the optical axis of the lens makes an angle of α of about 10° relative to the beam passing through the center of the lens and the center of the mirror. The lens is turned a little so that its optical axis no longer coincides with the beam passing through its center and the center of the mirror. Turning the lens in this way serves to optimize coverage of the blind spot and consequently to reduce the presence of the vehicle bodywork in the field of view where it is not necessary. As a result, the field of view points more to the side of the vehicle and less along the vehicle.

Furthermore, the beam passing through the center of the lens and the center of the mirror makes an angle β of about 10° relative to a longitudinal axis of the vehicle. Thus, the optical axis of the lens makes an angle of about 15° to 25° relative to the longitudinal axis of the vehicle, which is the axis of the window in the vehicle door.

By means of the invention, it is possible to provide a rearview mirror having only one lens and only one mirror. The lens can be a lens that defines a linear focus that can advantageously be combined with a mirror that is cylindrical and preferably parabolic. Because of its linear local focus, the lens generates optical distortion only in the horizontal plane and not at all in the vertical plane. Thus, the mirror need only correct horizontal optical distortion, and a particularly advantageous shape is that of a cylindrical mirror with its director curve being advantageously parabolic. The mirror of the invention in any event performs two functions: firstly the conventional function of reflection, and secondly the less conventional function of correcting like a lens. It can thus be considered that the mirror of the invention incorporates both a conventional mirror and a lens serving to correct the optical distortion generated by the diverging concave lens. It should be observed that the linear focus lens can be used with an arbitrary mirror, including a mirror that need not necessarily be cylindrical, or parabolically cylindrical. Symmetrically, the mirror of the invention that is cylindrical, and preferably a parabolic cylinder, can be used with any lens, including a lens that need not necessarily have a linear focus. In other words, both the lens and the mirror are suitable for being protected independently of each other.

The invention is described in greater detail below with reference to the accompanying drawings showing an embodiment of the invention by way of non-limiting example.

In the figures:

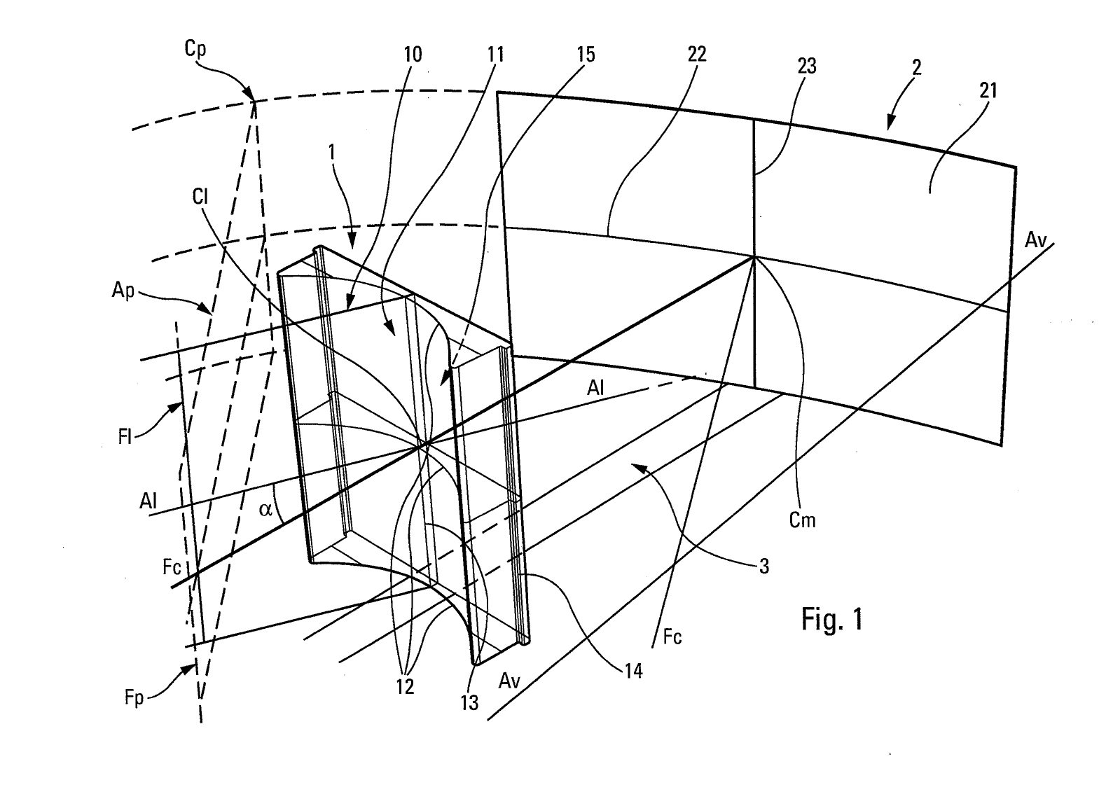

FIG. 1 is a diagrammatic perspective view of a lens and a mirror in a first non-limiting embodiment of a motor vehicle rearview mirror of the invention;

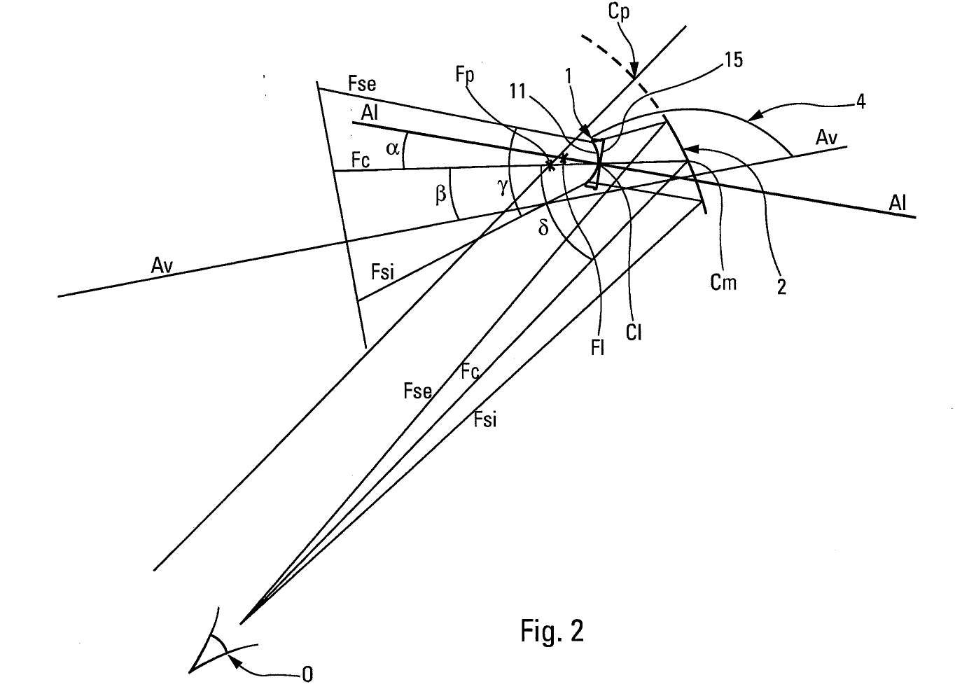

FIG. 2 is a schematic optical diagram for the FIG. 1 rearview mirror;

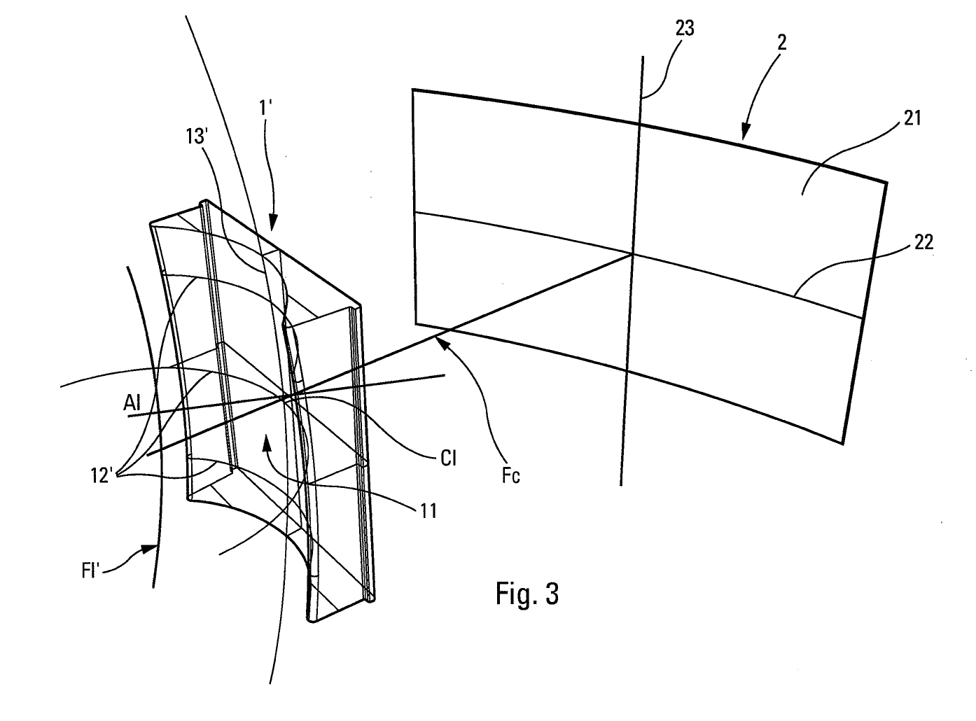

FIG. 3 is a view similar to FIG. 1 showing a rearview mirror using a lens in a second embodiment of the invention;

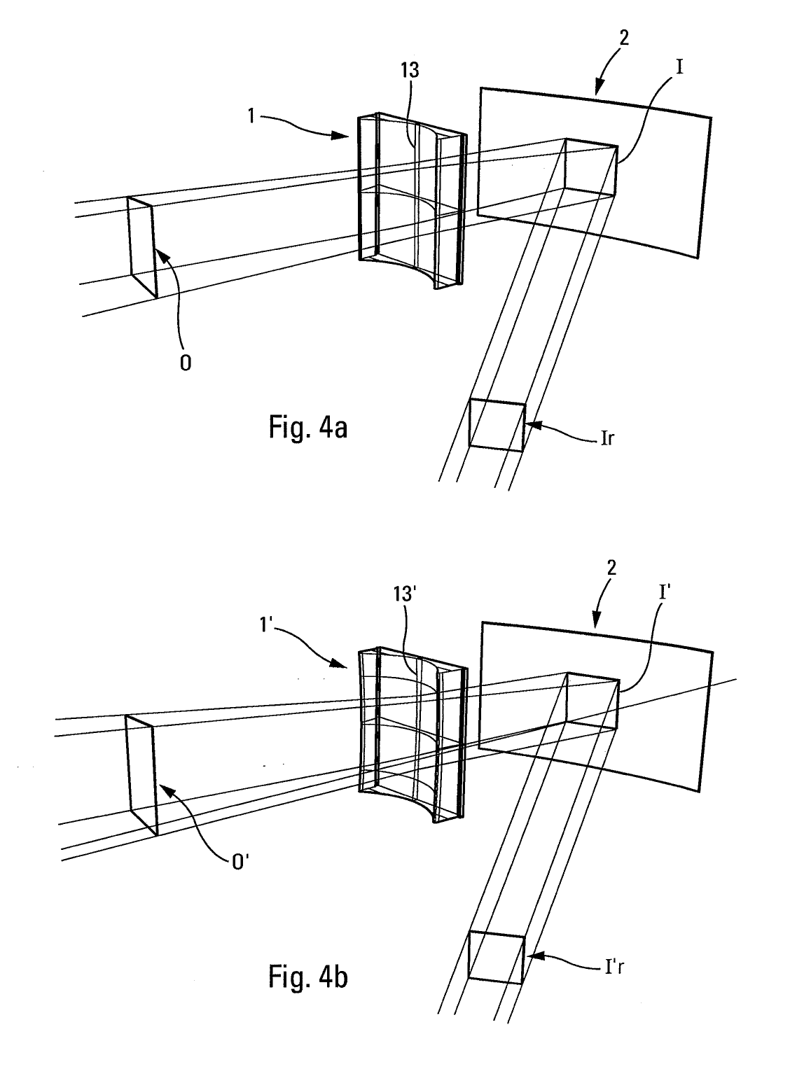

FIGS. 4a and 4b are diagrammatic perspective views showing the difference in terms of image between the first and second embodiments of FIGS. 1 and 3;

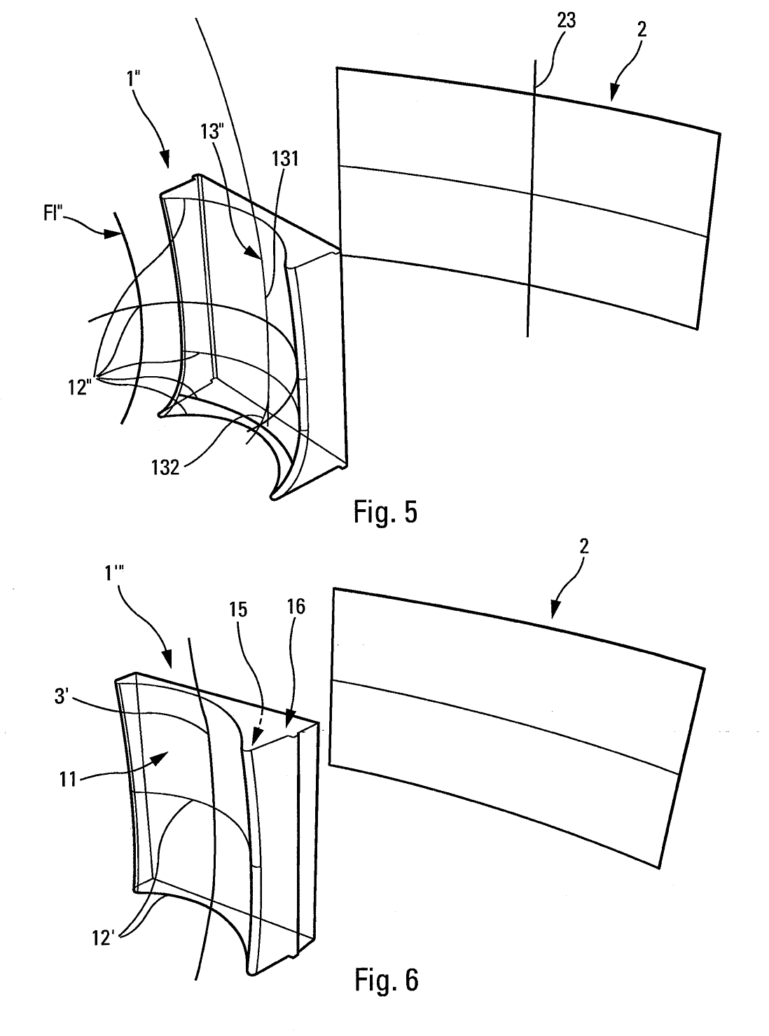

FIGS. 5 and 6 are views similar to FIGS. 1 and 3 for third and fourth embodiments respectively of a rearview mirror of the invention; and

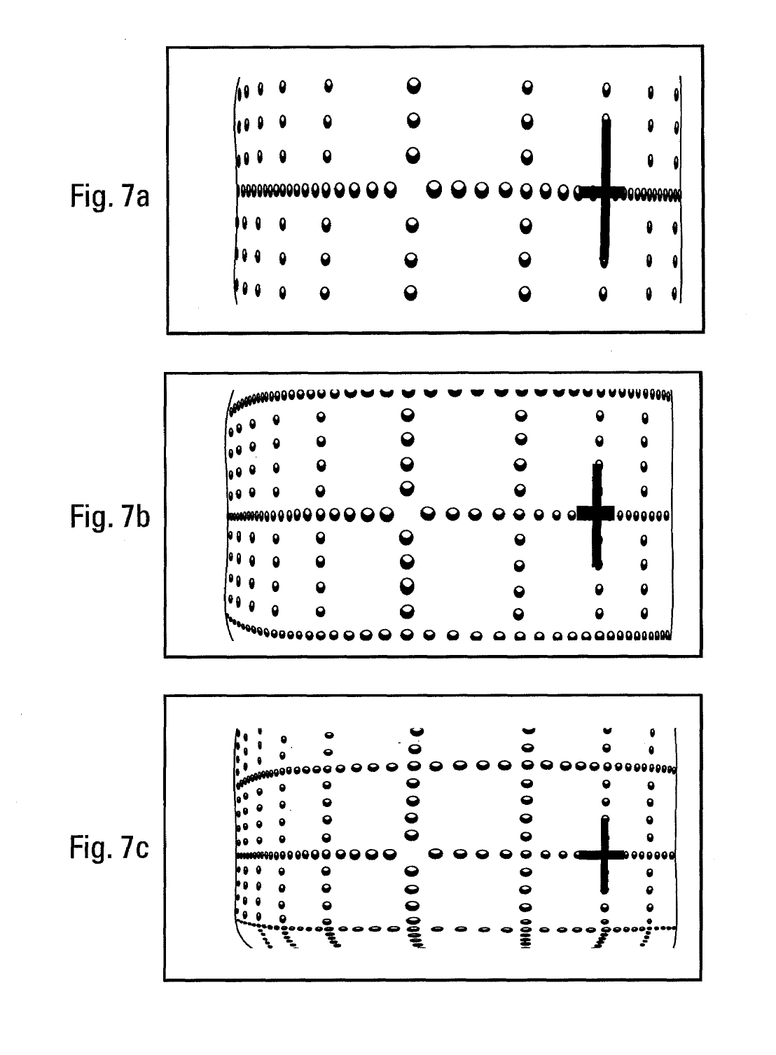

FIGS. 7a, 7b, and 7c are views of the mirror showing the field lines that correspond respectively with the mirrors of FIGS. 1, 3, and 5.

With reference initially to FIGS. 1 and 2, there can be seen in highly diagrammatic manner and in perspective the two essential component elements of the rearview mirror in the first embodiment of the present invention. These two elements are respectively a lens 1 and a mirror 2. The lens and the mirror can be mounted on a common support 3 that may present any appropriate shape. In FIG. 1, the support 3 is represented diagrammatically by a rod or bar connecting the lens 1 to the mirror 2. The support 3 is an optional element, and the lens 1 and the mirror 2 could be mounted on supports that are independent or disassociated. In addition to these three elements, the rearview mirror may include a fourth element that can be seen in FIG. 2: this is a shell 4 that covers the lens 1 and the mirror 2, and optionally the support 3. This shell 4 co-operates with the bodywork or a window of the vehicle to define an internal housing for receiving the lens 1 and the mirror 2. The shell 4 is likewise an optional element.

The lens 1 is a diverging concave lens presenting a concave front face 10 and a plane rear face 15. Thus, light beams passing through the lens from its concave face 10 are diffracted in diverging manner on exiting through the plane face 15. In this example, the front face 10 defines a concave optical surface 11 that is substantially or perfectly cylindrical. The optical surface 11 may be defined as having horizontal lines 12 and vertical lines 13 (with only the vertical mid-line being shown). Given that the optical surface 11 is cylindrical, the vertical lines 13 are straight lines that are all parallel to one another. In contrast, the horizontal lines 12 are curved, but nevertheless likewise parallel to one another. Advantageously, the curvature of the horizontal lines 12 is circular so that each forms a circular arc of constant determined radius. Thus, the optical surface 11 can be defined as being a fraction or segment of a circular cylinder.

The lens 1 of general or overall shape that is cylindrical or elongate defines an optical axis, or more precisely an optical plane Al that contains the vertical mid-line 13. This cylindrical lens thus defines a focus Fl that is an optical focal line that extends in the optical plane Al at a distance from the lens that corresponds to the focal length of the lens. This can be seen in FIG. 1. This focal distance may be of the order of 8 centimeters (cm) to 10 cm. Naturally, the linear focus Fl is situated on the same side as the concave optical surface 11. Given that the optical surface 11 is cylindrical, the focal line Fl is a straight line that extends vertically, parallel to the vertical mid-line 13, and as a result perpendicularly to the planes in which the horizontal lines 12 lie.

Furthermore, the lens 1 defines a fastener edge 14 that serves for example to engage the lens in order to fasten it to any suitable support.

The mirror 2 has a reflective surface 21 that, in this example, is substantially in the form of a prone rectangle, i.e. a rectangle having its long sides extending horizontally and its short sides extending vertically. Nevertheless, the mirror may define a reflective surface 21 having some other configuration, for example oval, elliptical, oblong, polygonal, or of some complex geometrical shape. In the invention, the reflective surface 21 presents a complex concave configuration. Nevertheless, the concave side of the reflective surface may be thought of overall, approximately, or substantially as a segment, fraction, part, or portion of a vertical cylinder. The reflective surface 21 defines a horizontal center line 22 and a vertical center line 23 that intersect substantially at the center Cm of the mirror. Given that the cylinder is vertical or upstanding, the vertical line 23 is a straight line, as are all the other parallel vertical lines. Furthermore, the horizontal line 22 is of substantially or perfectly parabolic shape, as are all of the other horizontal lines parallel to the line 22. More precisely, the reflective surface 21 is a segment of a cylinder having a parabolic director curve. In other words, the cross-section of the cylinder is of parabolic shape. The horizontal line 22 and all of the other horizontal lines are of parabolic shape, and therefore pass through the center line Cp of the parabolic center of the cylinder. Any parabola is defined by a parabola axis or parabola axis of symmetry and also by a parabola focus. A parabola is also defined by a parabola directrix (not shown). When the center of the parabola is projected along the generator line of the cylinder (which is vertical in this example), then the point center is transformed into a center line that corresponds to Cp in FIG. 1. Similarly, when the axis of symmetry of the parabola is projected along the generator line of the cylinder, this axis is transformed into a plane of symmetry referenced Ap in FIG. 1. The plane Ap is vertical in this example, given that the mirror 2 is placed with its vertical mid-line 23 extending vertically. Similarly, the focus of the parabola (which is a point) is transformed into a parabola focal line on being projected along the vertical generator line of the cylinder. This parabola focal line is referenced Fp in FIG. 1. This focal line Fp is parallel to the center line Cp, which is likewise parallel to the vertical mid-line 23 of the mirror 2. The parabola center line Cp and the parabola focal line Fp can also be seen in FIG. 2.

The lens 1 and the mirror 2 are mutually positioned relative to each other so that the rear plane face 15 of the lens faces towards the reflective surface 21 of the mirror. Nevertheless, if it is considered that the support 3 defines a support axis, then neither the lens 1 nor the mirror 2 is placed perpendicularly to the support axis. The lens 1 is turned a little and the mirror 3 is turned significantly so that the center beam Fc passing through the center Cl of the lens and the center Cm of the mirror 2 is reflected back towards the eye O of the driver. The angle δ between the incident central beam and the reflected central beam is of the order of 20° to 50°. Furthermore, given that the lens 1 is turned a little, the angle α between the optical axis Al of the lens and the central beam Fc passing through the center of the lens and the center of the mirror is of order of 5° to 15°, e.g. 10°.

With reference to FIG. 2, there can clearly be seen the angles α and δ. Furthermore, the central beam Fc is oriented relative to the longitudinal axis of the vehicle so as to make an angle β that can likewise be of the order 5° to 15°, e.g. 10°. The axis Av can also be considered as being the axis of the driver's door or of the window of the driver's door. Thus, the rearview mirror of the invention needs to be installed on the vehicle in such a manner that the central beam makes an angle β relative to the door. In this configuration, the lens 1 is situated outside the vehicle, while the mirror 2 is situated in part inside the vehicle and in part outside the vehicle. Naturally, because of the shell 4, the mirror 2 can be situated in a space that communicates with the inside of the vehicle and that is separated from the outside of the vehicle by the shell 4. The lens 1 then acts to close off the internal space formed by the shell 4 and acting as an entrance for light into the inside of the shell where the mirror 2 is located.

The viewing angle γ produced by the lens 1 may be of the order of 35°, whereas with a conventional rearview mirror, the viewing angle is limited to about 25° only. The inner side beam Fsi intersects the longitudinal axis Av so as to enable a portion of the bodywork to be seen. On the opposite side, the outer side beam Fse serves to enlarge the field of view into the conventional blind spot of a conventional rearview mirror. Thus, beams passing through the lens 1 are directed in diverging manner towards the concave mirror 2, which reflects the beams in converging manner substantially without optical distortion towards the eye O of the driver.

Concerning the mutual orientation of the mirror and the lens, the respective generator lines of the cylinder forming the mirror and the cylinder forming the lens are disposed in parallel manner. More specifically, the vertical mid-line 23 of the mirror is disposed substantially parallel to the vertical mid-line 13 of the optical surface 11 of the lens 1. Similarly, the horizontal center line 22 of the mirror is situated in the same plane as the horizontal mid-line 12 of the lens 1. Concerning the distance between the lens 1 and the mirror 2, it can be said that the linear focus Fp of the parabolic cylinder of the mirror is situated close to the linear focus Fl of the lens. This can be seen equally well in FIG. 1 and in FIG. 2. It can also be observed that the linear focus of the parabolic cylinder Fp is situated on the beam Fc passing through the center Cl of the lens and the center Cm of the mirror. The linear focuses Fp and Fl preferably extend parallel to each other, but they do not coincide; there is thus a distance between them. This distinction between the linear focuses makes it possible to cause the beams reflected by the mirror and directed towards the eye of the driver to converge.

Given that the lens 1 and the mirror 2 are both of a cylindrical configuration and both extend along parallel generator lines, the horizontal cross-section view of FIG. 2 is entirely representative of FIG. 1, and may be situated up any height of the lens or the mirror.

Forming the lens with an optical surface 11 that is of substantially or perfectly cylindrical configuration is particularly advantageous, both from the optical point of view and from the fabrication point of view. From the optical point of view there is no optical distortion in the vertical direction, with beams passing without diffraction or distortion through the lens via the vertical mid-line 13. Diffraction takes place in the horizontal plane only. In terms of fabrication, this is made simpler because of the cylindrical shape of the optical surface, which is a geometrical shape that is relatively simple to make.

The parabolic cylindrical shape for the mirror is also advantageous in combination with the cylindrical lens or with some other lens of arbitrary shape. The cylindrical mirror is just as easy to make as is the cylindrical lens, because of the ease with which it is possible to make a cylindrical surface. Combining the parabolic cylindrical mirror with the cylindrical lens is nevertheless advantageous given that the parabolic cylindrical mirror 2 does not need to correct any optical distortion coming from the lens, given that the lens does not diffract in the vertical plane. Optical distortion thus takes place only in the horizontal plane, and this distortion is easily corrected by the mirror 2 by virtue of its parabolic cylindrical shape. An image is thus obtained that is compressed in the horizontal plane and without distortion in the vertical plane. This is shown in FIG. 7a which shows what a driver sees when looking in the mirror. The various spots visible in the mirror represent or give an indication of the density of field lines both horizontally and vertically. The cross situated to the right-hand side of the rearview mirror represents the axis of the road at the horizon. It can be seen that the density of spots in the horizontal field mid-line is large, in particular at the edges, whereas the density of spots in the vertical field lines is constant. This rearview mirror gives an image that is highly compressed horizontally, but that is real vertically. The proportions of objects are therefore not conserved.

With reference to FIG. 3, there follows an explanation of how it is possible to correct for this loss of proportion. In the second embodiment shown in FIG. 3, the mirror may be identical to the mirror of the first embodiment. However, the lens 1′ differs from the lens 1 of the first embodiment in that the vertical mid-line 13′ in this embodiment is curved, with curvature advantageously corresponding to a circular arc. In the first embodiment, the mid-line 13 is substantially or perfectly rectilinear, and it extends parallel to the vertical mid-line 23 of the mirror 2. In the second embodiment, the curved vertical mid-line 13′ extends in a plane that likewise contains the vertical mid-line 23 of the mirror. The horizontal lines 12′ of the lens 1′ are curved, as in the first embodiment, and their curvature preferably corresponds to a circular arc. The various horizontal lines 12′ are substantially parallel to one another, or more precisely the various curves 12′ extend in respective planes that are perpendicular to the vertical line 13′. It can also be said that the plane in which a horizontal curve 12′ extends is perpendicular to the tangent to the vertical line 13′ where said plane intersects the line 13′. Because the curvature of the vertical line 13′ is small, as can be seen in FIG. 3, the horizontal curves 12′ extend substantially parallel. The rear optical surface 11′ of the lens 1′ thus defines a segment of a torus of cross-section that is defined by the horizontal lines 12′ and of curved longitudinal extent that is defined by the vertical lines 13′. A torus may be defined as a tube of circular section that presents defined curvature. In this embodiment, the curvature is advantageously circular, as is the curvature of the lines 12′.

Such a lens 1′ also defines a focal line Fl′. Nevertheless, because the vertical line 13′ is curved, and no longer straight, the rays passing through the mid-line 13′ are also diffracted, except those passing through the center Cl. Optically, this has the effect of shrinking the image in the mirror. This is what is shown in FIGS. 4a and 4b. In FIG. 4a, there can be seen an object of that is of rectangular geometrical shape for reasons of simplicity, after passing through the lens 1 of the first embodiment gives an image I that is substantially square in the mirror 2. As a result, the driver sees an image Ir that is substantially square. In FIG. 4b, the object O′ is larger than the object O: the long sides of the rectangle of the object 0′ are longer than the long sides of the object 0. On passing through the lens 1′, an image I′ is obtained in the mirror 2 that is substantially square in shape, like the image I in FIG. 4a. As a result the driver will see an image Ir′ that is substantially identical to the image Ir of FIG. 4a. Thus, objects O and O′ of different vertical sizes give rise to reflective images Ir and Ir′ that are seen to be substantially identical. This comes from the fact that the vertical line 13′ of the lens 1′ is slightly curved, whereas the vertical line 13 is perfectly rectilinear. The effect of the curvature of the line 13′ to reduce the height of the image I′, which corresponds to compressing the optical field lines. Symmetrically, it can be said that an object of identical height will present images Ir′ of different heights, the image Ir being compressed vertically more than the image Ir.

Thus, the curvature of the vertical line 13′ of the mirror 2′ serves to reestablish the proportions in the reflective image as seen by the driver either approximately, substantially, or indeed perfectly. This is shown in FIG. 7b, which is a view similar to FIG. 7a with a rearview mirror as shown in FIG. 3, i.e. with a lens 1′ having its vertical line 13′ with a small amount of clearance. Compared with the view in FIG. 7a, it can be said that the vertical field lines represented by vertical lines of spots are spaced apart by intervals that are identical to those of FIG. 7a. In contrast, it can be seen that the horizontal field lines are closer together, given that three horizontal field lines can be seen in FIG. 7b, whereas only the middle horizontal field line can be seen in FIG. 7a. It can readily be understood from these diagrams of the image visible in the mirror that the proportions of objects are more faithfully reproduced than with the mirror of FIG. 3: the spacing between the horizontal spots in FIG. 7b is substantially identical to the spacing between the vertical spots. This is not true in FIG. 7a where the spacing between vertical spots is significantly greater than the spacing between horizontal spots. Consequently, with a rearview mirror as shown in FIG. 3, the object conserves proportions that are approximately natural.

An essential characteristic that is common to the lenses 1 and 1′ is that both of them define a respective optical focus that extends along a line. Nevertheless, whereas the linear optical focus Fl of the lens 1 is perfectly rectilinear, the linear optical focus of the lens 1′ is curved, to match the curvature of its vertical mid-line 13′.

FIG. 5 shows a variant of the FIG. 3 rearview mirror. The mirror 2 may be identical to that of the first and second embodiments of FIGS. 1 and 3. However the lens 1″ differs from the lens 1′ in that the curvature of its vertical line 13″ is greatly increased in its bottom zone. The vertical line 13″ can thus be subdivided into two zones, namely a main zone 131 that extends over the major fraction of the height of the lens and a bottom zone 132 that is limited approximately to the bottom fourth of the height of the lens. The curvature of the main zone 131 may be identical to the curvature of the line 13′ of the second embodiment shown in FIG. 3. The curvature of the zone 131 may advantageously be circular so as to define a circular arc. The bottom zone 132 presents increased curvature, which may also correspond to a circular arc. The increase in the curvature in the zone 132 is achieved by thickening the lens, as can be seen in FIG. 5. As for the “horizontal” lines 12″, they present curvature that is advantageously identical and that corresponds to a circular arc. The various curvatures 12″ extend in planes that are perpendicular to the line 13″, as in the second embodiment. Thus, the curvatures 12″ in the bottom zone 132 lie in planes that are more and more vertical, given that the curvature of the vertical line 13″ in the zone 132 is very considerable. Referring to the lines 12″ as “horizontal” lines is not exactly true in this embodiment, given that the lines 12″ in the zone 132 lie in planes that depart considerably from the horizontal. Nevertheless, for reasons of clarity and understanding, these lines 12″ continue to be called “horizontal” lines, given that they extend in planes that are perpendicular to the vertical line 13″. Symmetrically, the vertical line 13″ is not strictly vertical, given that it presents two distinct curvatures. Nevertheless, it can be said that the line 13″ extends in a vertical plane that also contains the vertical mid-line 23 of the mirror 2. As in the first two embodiments, this lens 1″ defines an optical focus in the form of a focal line Fl″.

Concerning the image visible when looking into the rearview mirror of FIG. 5, it corresponds to what is shown in FIG. 7c. The density of the horizontal lines is substantially identical to that of FIG. 7b, given that the curvatures of the horizontal lines 11″ are substantially identical. In contrast, the density of the vertical lines increases strongly in the bottom portion of the rearview mirror, corresponding to the bottom zone 132 of the lens. It can be seen that the density of the vertical lines is substantially constant over the major fraction of the height of the rearview mirror corresponding to the main zone 131. Nevertheless, the density of the vertical lines can be seen to increase compared with FIG. 7b. This produces curvature for the line 13″ that is slightly stronger than that of the line 13′. In contrast, the density of vertical lines in the bottom portion of the rearview mirror is very high, which makes it possible to see down to the road surface directly beside the vehicle. With such a rearview mirror, the driver can see a sidewalk beside which the driver seeks to park. This makes it possible to park a car accurately parallel to the sidewalk and as close as possible thereto. Thus, it can be said that the main function of the bottom zone 132 is to enable the driver to see the road surface directly beside the vehicle. Naturally, the images in the bottom portion of the rearview mirror are highly distorted, whereas distortion is limited or non-existent in the major fraction of the rearview mirror. Consequently, the rearview mirror of FIG. 5 gives a view that is practically ideal and particularly extensive. Objects retain their proportions both horizontally and vertically, and the blind spot is particularly well covered, and in addition the driver can see the sidewalk beside which the car is to be parked.

Once more the lens 1″ also defines a linear optical focus Fl″ that is lightly curved in a manner that corresponds to the line 13″.

With a quick reference back to FIG. 2, it can be seen that the lens is situated outside the vehicle represented by the line Av, whereas the mirror 2 lies across this line. This means that the rearview mirror is situated in part outside the vehicle and in part inside the vehicle. For various reasons, it can be preferable to place the mirror as far inside as possible. This is possible using the rearview mirror of FIG. 6 in which the lens 1″′ incorporates a prism 16. The prism has the well-known function of deflecting light beams without diffraction or optical distortion. The prism 16 is incorporated in the lenses in such a manner as to constitute a one-piece optical component. The optical surface 11′ may be identical to that of FIG. 3. The prism 16 has the effect of increasing the thickness of the lens on the right-hand side and decreasing the thickness of the lens on the left-hand side, as seen in FIG. 6. This means that the front face 15 of the lens 1″′ lies in a plane that is pivotally offset about a vertical axis relative to the front faces of the lenses of the other embodiments. This change in the orientation of the front face has the effect of giving a prismatic function to the lens suitable for deflecting light rays exiting the lens without distortion or diffraction. As a result, the light rays are offset to the right, so the mirror 2 can be offset to the right, i.e. into the inside of the vehicle passenger compartment. By further increasing the inclination of the front face 15 of the prism 16, it is possible to further offset the mirror 2 in corresponding manner towards the inside of the vehicle. Such a prismatic function can be implemented with the other embodiments as shown in FIGS. 1, 3, and 5. The same applies to the bottom zone 132 of FIG. 5, which can be likewise implemented in the other embodiments of FIGS. 1, 3, and 6. An ideal rearview mirror can be found in combining the embodiments of FIGS. 5 and 6, giving an image corresponding to that of FIG. 7c with a mirror that is situated inside the vehicle passenger compartment.

It should be observed that in all of the embodiments, the mirror can be identical and is advantageously formed by a segment of a cylinder presenting a director curve that is parabolic. This comes from the fact that all of the lenses in the various embodiments define an optical focus in the form of a line and not a point.

The various lenses 1, 1′, 1″, and 1″′ can be implemented independently of the parabolic cylindrical mirror, and can be used with any mirror. In other words, these lenses can be used in optical devices other than a rearview mirror. Each lens is thus suitable for independent protection. The mirror having a parabolic cylindrical shape can also be implemented independently of the lenses 1 to 1″′. Its parabolic cylindrical shape is particularly advantageous for reasons of design and fabrication, such that the mirror can be used in other applications, applications not involving a rearview mirror. It is thus also possible to envisage protecting this mirror independently.

All of the lenses 1, 1′, 1″, and 1″′ present an overall configuration that is rectangular. Nevertheless, the lens could present some other overall configuration, e.g. round, oblong, elliptical, square, etc., while conserving an optical surface that is generally substantially or perfectly cylindrical.

Unlike rearview mirrors making use of circularly symmetrical lenses with a point optical focus, the rearview mirror of the present invention makes use of linear geometry such that the mirror and also the lens present a configuration that is generally substantially or perfectly cylindrical with director curves of shapes that are relatively simple, such as a circle or a parabola.

1. A motor vehicle rearview mirror for producing an image of an object situated outside and behind the vehicle, the rearview mirror comprising a lens (1; 1′; 1″; 1″″) and a mirror (2) and being characterized in that the lens is a diverging concave lens having an optical axis (Al) and an optical focus (Fl; Fl′; Fl″), and the mirror is a mirror that is substantially concave, light beams (Fse, Fc, Fsi) passing through the diverging lens towards the mirror that reflects them in converging manner substantially without optical distortion in a direction that corresponds to the viewing axis of the driver looking at the mirror, characterized in that the mirror (2) defines a concave reflective surface (21) that corresponds substantially to a segment of a cylinder.

2. A rearview mirror according to claim 1, having only one lens and only one mirror.

3. A rearview mirror according to claim 1, in which the cylinder defines a director curve that is substantially parabolic, such that the cylinder is parabolic and presents a plane of symmetry and a focal line situated in said plane.

4. A rearview mirror according to claim 3, in which the plane of symmetry is substantially parallel to the viewing axis of the driver looking at the mirror.

5. A rearview mirror according to claim 1, in which the reflective surface (21) of the mirror defines a horizontal mid-line (22) and a vertical mid-line (23) that intersect substantially at the center (Cm) of the mirror, the horizontal line having substantially parabolic curvature, the vertical line being substantially straight, all of the vertical lines being likewise straight and all of the horizontal lines having the same parabolic curvature as the horizontal mid-line.

6. A rearview mirror according claim 1, in which the optical focus of the lens defines a focal line.

7. A rearview mirror according to claim 6, in which the focal line is disposed substantially vertically relative to the mirror.

8. A rearview mirror according to claim 3, in which the respective focal lines of the cylinder and of the lens are substantially parallel, and distinct.

9. A rearview mirror according to claim 6, in which the focal line of the cylinder is situated close to the optical axis of the lens.

10. A rearview mirror according to claim 1, in which the lens has a concave front face and a rear face that is substantially plane and directed towards the mirror, the front face defining an optical surface (11) having a configuration that is substantially cylindrical.

11. A rearview mirror according to claim 10, in which the optical surface defines a horizontal mid-line (12; 12′; 12″) and a vertical mid-line (13; 13′, 13″) that intersect substantially at the center (Cl) of the optical surface, the horizontal mid-line presenting curvature in a plane perpendicular to the vertical mid-line, all of the horizontal lines having substantially the same curvature as the horizontal mid-line in respective planes perpendicular to the mid-line.

12. A rearview mirror according to claim 11, in which the vertical mid-line (13) is straight, as are all of the other vertical lines.

13. A rearview mirror according to claim 11, in which the vertical mid-line (13′; 13″) is curved, such that the optical surface presents a general configuration that is toroidal.

14. A rearview mirror according to claim 11, in which the vertical mid-line (13″) presents a bottom zone (132) in which its curvature is stronger.

15. A rearview mirror according to claim 1, in which the lens (1″′) presents a prismatic configuration (16) suitable for deflecting light beams towards the inside of the car.

16. A rearview mirror according to claim 1, in which the optical axis (Al) of the lens makes an a of about 10° relative to the beam (Fc) passing through the center (Cl) of the lens and the center (Cm) of the mirror.

17. A rearview mirror according to claim 1, in which the beam (Fl) passing through the center (Cl) of the lens and the center (Cm) of the mirror form an angle β of about 10° relative to a longitudinal axis (Av) of the vehicle.
